(19) United States
(12) Patent Application Publication
(10) Pub. No.: US 2004/0176969 A1
(43) Pub. Date: Sep. 9, 2004

(54) Vehicle sharing system

(76) Inventor: Michio Fujinuma, Sayama-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/472,189

(22) PCT Filed: Mar. 29, 2002
(86) PCT No.: PCT/JP02/03199

(30) Foreign Application Priority Data
Apr. 3, 2001 (JP) 2001-105074
Apr. 3, 2001 (JP) 2001-105075
Apr. 3, 2001 (JP) 2001-105076

(51) Int. Cl. G06F 17/60

(52) U.S. Cl. 705/1

(57) ABSTRACT

When a user accesses a control center by using a portable terminal, whether or not a “reserved rental” is available is designated according to a date in which the shared motor vehicle is used. For example, only the “non-reserved rental” is permitted from Monday through Friday in which a motor vehicle is often used for a short period of time. “Reserved rental” is compatibly employed on Saturday, Sunday, and holiday in which a motor vehicle is used on a planned schedule. It is determined whether or not the designated date indicates that a reservation is possible, thus, if the designated date indicates that a reservation is possible, a reservation is accepted. Thus, a useful motor vehicle sharing system for the user can be provided in which an operating ratio of the motor vehicles does not decrease even if the “reserved rental” and the “non-reserved rental” coexist. Also, when a user accesses a control center by using a portable terminal, a number or the motor vehicles which are parked in each port is calculated according to an inputted reservation condition. If there is a port in which it is difficult to park more motor vehicles, a reservation for using the motor vehicle which is supposed to arrive the port is stopped. The stopped reservation is allocated to the motor vehicle after the port has a vacancy for parking the shared motor vehicle; thus, a message that a reservation is completed is transmitted to the user. Also, it is determined whether or not a model of a shared motor vehicle which is actually requested to use by the user is the same as the reserved model. If the model of a shared motor vehicle which is requested to use by the user is not the same as the reserved model, the number of the motor vehicle which can be used and the number of the reserved motor vehicles are changed for both of the present model and the reserved model; thus, it is permitted that the user may enter the motor vehicle of the present model, and a rental permission transmitted to the shared motor vehicle.

### TECHNICAL FIELD

The present invention relates to a management system for motor vehicles which are used commonly by a plurality of users. In particular, the present invention relates to a motor vehicle sharing system which is most suitable for increasing an operation ratio of motor vehicles, reducing time for allocating motor vehicles, and improving quality of service for users when making reservations for motor vehicles.

### BACKGROUND ART

Conventionally, various proposals for motor vehicle sharing systems have been made for purposes of efficient usage of a motor vehicles by a plurality of users so as to obtain transportation smoothly and reliably.

For such proposals, for example, Japanese Patent Granted Publication No. 2,890,108 proposes an unattended motor vehicle rental system which can deal with both cases of reserved rentals and non-reserved rentals compatibly. Also, Japanese Unexamined Patent Application, First Publication No. Hei 11-338935 discloses a technology in which a motor vehicle rental system for making reservations via a portable communication apparatus for a key to utilize the reserved motor vehicle.

Also, Japanese Unexamined Patent Application, First Publication No. 8-44801 discloses a technology for a motor vehicle rental system for using motor vehicles commonly based on a contract which is made between a user and a control center comprising a communication section for each of a plurality of motor vehicles and a control center for controlling the motor vehicles according to information which is sent via the communication section. Also, the document proposes a multi-port motor vehicle rental system which is provided with a plurality of ports where the above motor vehicles are prepared in the ports as a parking area such that the user can transport among the ports freely.

In the above motor vehicle rental system in which the motor vehicles are used commonly, the motor vehicles are used in either one of rental forms such as an ordinary rental method which is called a “reserved rental” in which a particular motor vehicle which is parked in the port is reserved when the user make a reservation to a controlling center in advance, or as a rental method such as a “non-reserved rental” in which a user uses the motor vehicle which is parked in the port not by making a reservation but by picking up a motor vehicle directly.

However, according to the above conventional technology, both methods such as the “reserved rental” and the “non-reserved rental” can be handled in the motor vehicle rental system; therefore, it is easy for the users to use. However, the procedure for the “reserved rental” remains the same as conventional rental procedures; thus, it is necessary to reserve a particular type of motor vehicle when such a type is reserved by the user. Therefore, it is not possible to use the motor vehicle for a period in which the motor vehicle is reserved until the user rents the motor vehicle. Therefore, there has been a problem in that it is not possible to increase an operation ratio of the motor vehicles.

Also, in the case of a rental system in which a predetermined number of motor vehicles which are parked in the ports are used for the reserved rental exclusively, it is necessary to prepare more motor vehicles which are supposed to be used for the reserved rental while taking variations in the reservation numbers into account. In such a case, there have been problems in that a total number of motor vehicles which can be used for the “non-reserved rental” decreases; thus, it is not convenient for the user who desires to use the motor vehicle for a short time without making a reservation, and an operation ratio of the motor vehicles decreases when there are less reservations than anticipated.

Furthermore, although the above conventional multi-port system is easy to use for the user because the user can return the motor vehicle to a port which is close to the destination, there is congestion of motor vehicles in railway stations in the mornings and evenings or in the ports near restaurants at lunch-time. Because of such congestion of motor vehicles, there has been a problem in that it is not possible to return or park the motor vehicle in the port.

Also, when the congestion of motor vehicles occurs, it is necessary to reallocate the motor vehicles among the ports by staff's manpower so as to equalize the numbers of the motor vehicles which are parked in the ports. In particular, there has been a problem in that operation costs for the system increases as the congestion of the motor vehicle becomes worse; thus, more staff's manpower is necessary in a system in which a “non-reserved rental” can be performed in which it is possible to rent a motor vehicle at a near port without a reservation such that the motor vehicle can be used frequently so that the user can use the system easily.

Furthermore, in the above motor vehicle rental system in which the motor vehicles are used commonly, simple indications such as “Available”, “Not-Available”, and “Reserved (Being Reserved)” are displayed for each motor vehicle which is parked in the port. However, there has been a problem in that it is inconvenient for the user to find the particular motor vehicle which he (or she) reserved among the motor vehicles which display the indication of “Reserved” for indication a reserved rental condition in which the motor vehicle is limited.

Also, there has been a problem in that the user may have a complaint that the reserved vehicle is parked far away from the user even if the user finds the same type of vehicle near an entrance of the port.

Furthermore, there has been a problem in that it is not possible to deal with a user's request desirably in the conventional system in a case in which it is not possible to change the reservation easily when the user desires to use a different car in the port neighboring the car which he reserved.

The present invention was made in consideration of the above problems. An object of the present invention is to provide a motor vehicle sharing system in which the operation ratio of the motor vehicles does not decrease in a case in which the “reserved rental” form and the “non-reserved rental” form coexist such that it is easy to use for the users.

Also, other object of the present invention is to provide a motor vehicle sharing system which reduces the reallocating operation of the motor vehicles without decreasing the operation ratio of the motor vehicles in a motor vehicle rental system in which the “reserved rental” form and the “non-reserved” form coexist.

Furthermore, another object of the present invention is to provide a motor vehicle sharing system which can reallocate the motor vehicles in a manner for more focusing to the quality of the service for the users in a reservation by the motor vehicle rental system.

### DISCLOSURE OF THE INVENTION

In order to solve the above problems, in a first aspect of the present invention, in a motor vehicle sharing system which comprises a control center (for example, a control center 1 in an embodiment) which is provided with a controlling device for controlling a motor vehicle (for example a shared motor vehicle 2 in an embodiment) which is parked in a parking area for renting the motor vehicle to a user, wherein the controlling device comprises a data storing section (for example, a reservation master 17 in an embodiment) which stores a plurality of combinations of a motor vehicle rental form which is defined according to a length of time length of rental for a motor vehicle to a user and a period which is supposed to be applied for rental data for renting the motor vehicle to the user, a rental setting section (for example, a rental setting section 10 in an embodiment) switching the combinations of the motor vehicle rental forms periodically according to the applied period according to the rental data which is stored in the data storing section so as to rent the motor vehicle, and a price controlling section (for example, a price controlling section 102) which sets different prices according to the motor vehicle rental forms and charges a billing price to the user according to the user's usage condition of the motor vehicle.

According to the above structure, it is possible to realize a most preferable determination form based on usage tendency of the motor vehicles by the users by combining a plurality of motor vehicle rental forms which are categorized for time frame for the motor vehicle rental. Thus, it is possible to organize a motor vehicle sharing system which can realize an easy usage for the users by switching and setting usage dates and used time frames. Also, it is possible to let the user understand features in the motor vehicle rental form easily by pricing systems which are set for the motor vehicle rental forms.

In this case, the rental data contains a first setting period in which only the motor vehicle rental form for renting the motor vehicle on an an hourly basis is performed, and a second setting period in which either one of the motor vehicle rental form for renting the motor vehicle on a daily basis or the motor vehicle rental form for renting the motor vehicle on an hourly basis is selectively performed.

According to the above structure, it is possible to deal with the user's requirement by providing a motor vehicle rental form which can be used on a daily basis on a holiday in which the motor vehicle may be used for a longer time such that the user can select such a rental form. On the other hand, it is possible for a lot of users to use the motor vehicles by setting only a motor vehicle rental form in which the motor vehicle can be used on an hourly basis on weekdays such that the operation ratio of the motor vehicle improves.

Also, it is preferable that, in the price controlling section, a usage price for the motor vehicle rental form for renting the motor vehicle on an hourly basis increase in proportion with time, and that a usage price for the motor vehicle rental form for renting the motor vehicle on a daily basis be fixed for a day.

According to the above structure, differences in the motor vehicle rental forms between the motor vehicle usage for short periods and the motor vehicle usage for long periods becomes clear, and the user can choose a desirable motor vehicle rental form according to his (or her) preference. Thus, it is possible to construct a motor vehicle sharing system which is easy to use for the users in which user dissatisfaction regarding price can be softened.

In order to solve the above problems, as a second aspect of the present invention, in a motor vehicle sharing system comprising a control center (for example, a control center 1 in an embodiment) which is provided with a controlling device for controlling a motor vehicle (for example, a shared motor vehicle 2) which is parked in a parking area, which is called a port, for renting the motor vehicle to a user, wherein, the controlling device comprises a reservation registering section (for example, a reservation registering section 111) which performs a rental allocation of the motor vehicle according to a reservation information which contains a departing port and an arriving port which are from the user and calculates a planned number of motor vehicles to be parked for each port, and a reservation determining section (for example, a reservation determining section 112 in an embodiment) which stops the rental and the reservation of the motor vehicle which is supposed to arrive at a port when the planned number of motor vehicles to be parked in the port calculated by the reservation registering section reaches a parking capacity of the port.

According to the above structure, the reservation registering section estimates a planned number of motor vehicles to be parked in each port according to the reservation information before the motor vehicle is actually used. The reservation determining section finds a reservation which is about to be changed such that the number of motor vehicles will be set over the parking capacity and does not make such a reservation. Therefore, it is possible to prevent trouble in that it is not possible to park the motor vehicle because the arriving port is filled with motor vehicles in actual usage of the motor vehicle. In this case, it is preferable that a motor vehicle sharing system be provided with a stand-by reservation setting section (for example, a stand-by reservation setting section 113 in an embodiment) which lets the user select whether or not standing by a reservation via a user's terminal when a reservation for using a motor vehicle is stopped by the reservation determining section and records a stand-by reservation data of the user when the user desires standing by the reservation.

According to the above structure, reservation information which are not set are recorded to be under a stand-by status in an order in which the reservation occurs by the stand-by reservation setting section. By doing this, when the reservation determining section finds a reservation which is about to be changed such that the number of motor vehicles will be set over a parking capacity and does not make such a reservation, it is possible to soften the user's complaint as much as possible who wished such a reservation.

Also, it is preferable that a motor vehicle sharing system be provided with a stand-by reservation allocating section (for example, a stand-by reservation allocating section 114 in an embodiment) which uses the motor vehicle of which usage is stopped by the reservation determining section, cancels the reservation of the usage of the motor vehicle, and allocates the motor vehicle for the user whose stand-by reservation data is recorded in the stand-by reservation setting section preferentially wherein the planned number of motor vehicle to be parked is equal to the parking capacity in the arriving port.

According to the above structure, whether or not the motor vehicle can be used in a stopped direction is determined quickly, and the reservation is executed such that the motor vehicle is allocated immediately when the reservation is possible for the users who are standing by the reservation. By doing this, it is possible to improve the quality of the service for the users as much as possible. Furthermore, the stand-by reservation allocating section is provided with a notifying section (for example, a step S35 in a second embodiment) which notifies the user who desires standing by the reservation that the motor vehicle is allocated when the motor vehicle is allocated successfully.

According to the above structure, it is possible to notify the users who are standing by the reservation that the reservation is made successfully; thus, the quality of the service for the users can be improved.

In order to solve the above problems, as a third aspect of the present invention, in a motor vehicle sharing system comprising a control center (for example, a control center 1 in an embodiment) which is provided with a controlling device for controlling a motor vehicle (for example, a shared motor vehicle 2 in an embodiment) which is parked in a parking area which is called as a port for renting the motor vehicle to a user, the controlling device comprises an data storing section (for example, a reservation master 17 in an embodiment) which stores the number of motor vehicle available to be used with reference to a motor vehicle type information, a reservation registering section (for example, a reservation registering section 121 in an embodiment) which performs a reservation registration of the motor vehicle according to an information of the departing port and a reservation information which includes a preferred motor vehicle type information which are received from the user's terminal and updates the number of motor vehicle available to be used, and a renting section (for example, a renting section 122 in an embodiment) which permits the usage of the motor vehicle in the departing port according to the information of the user which is inputted by the user and the motor vehicle type information, and the renting section rents the motor vehicle of which type is inputted by the user as long as the motor vehicle is rentable when the motor vehicle type information which is included in the reservation information is different from the motor vehicle type information which is inputted by the user at the departing port, and the number of motor vehicle available to be used which is stored in the data storing section is greater than zero, and updates a content in the number of motor vehicle available to be used which is stored in the data storing section.

According to the above structure, a type of the motor vehicle is limited when a reservation is made for the vehicle such that the user may make a reservation only for the type of the motor vehicle but for a specific motor vehicle having its own ID, and the control center acknowledges the number of the number of motor vehicle available to be used based on a type of the motor vehicle and the number of the reserved motor vehicles. By doing this, whether or not the motor vehicle can be rented because the number of motor vehicle available to be used for the type of the motor vehicle which the user desires using can be confirmed immediately even if the user desires using a different type of motor vehicle from the reserved type when the motor vehicle is rented.

In this case, it is preferable that the renting section should rent the motor vehicle of which type is inputted by the user as long as the motor vehicle is rentable when the information of the user which is inputted at the departing port is not registered in the reservation registration which is registered by the reservation registering section when the number of motor vehicle available to be used which is stored in the data storing section is greater than zero, and updates a content in the number of motor vehicle available to be used which is stored in the data storing section.

According to the above structure, it is possible to compensate the lack of motor vehicle which is used for a “non-reserved rental” with regardless to whether or not there is a reservation in which a vacant motor vehicle is used directly at the port for the user who does not reserve a motor vehicle by renting a requested type of motor vehicle to the user.

Also, it is preferable that the motor vehicle type information contains information which indicates at least any one of a type of a motor vehicle, a type of a driving force transmitting function, equipments, and a color of a body of the motor vehicle.

According to the above structure, it is possible to control the motor vehicles based not only on a type of the motor vehicle but also on further detailed categorized factors such as an engine, a transmission, a driving method such as two-wheel-driving or four-wheel-driving, equipments such as a sunroof, colors of the motor vehicle. Thus, the user can find the motor vehicle which is more desirable for the user easily and use it.

### BRIEF DESCRIPTION OF DRAWINGS

FIG. 1 is a block diagram for a structure used in a first embodiment of the present invention.

FIG. 2 is a general structure of a shared motor vehicle which is used in the embodiment.

FIG. 3 shows a port in which a shared motor vehicle which is used in the embodiment is parked.

FIG. 4 is an overall operation of the motor vehicle sharing system in the embodiment.

FIGS. 5A and 5B show days in which the reservation can be made in the motor vehicle sharing system in the embodiment.

FIG. 6 shows reservation processing operations in the motor vehicle sharing system in the embodiment.

FIG. 7 shows reservation processing operations in the motor vehicle sharing system in the embodiment.

FIG. 8 shows usage prices for each rental form in the motor vehicle sharing system in the embodiment.

FIG. 9 shows operations for returning a motor vehicle in the motor vehicle sharing system in the embodiment.

FIG. 10 is a block diagram of a second embodiment of the present invention.

FIG. 11 shows reservation processing operations in the motor vehicle sharing system in the embodiment.

FIG. 12 shows reservation processing operations in the motor vehicle sharing system in the embodiment.

FIG. 13 shows an example for controlling a number of the motor vehicles for each port and availability of the reservation of the motor vehicle sharing system in the embodiment.

FIG. 14 shows operations for returning a motor vehicle in the motor vehicle sharing system in the embodiment.

FIG. 15 is a block diagram of a third embodiment of the present invention.

FIG. 16 shows reservation processing operations in the motor vehicle sharing system in the embodiment.

FIG. 17 shows reservation processing operations in the motor vehicle sharing system in the embodiment.

FIG. 18 shows determining processing operations for the rental of the motor vehicle in the motor vehicle sharing system in the embodiment.

### BEST MODE FOR CARRYING OUT THE INVENTION

Embodiments of the present invention are explained with reference to drawings below.

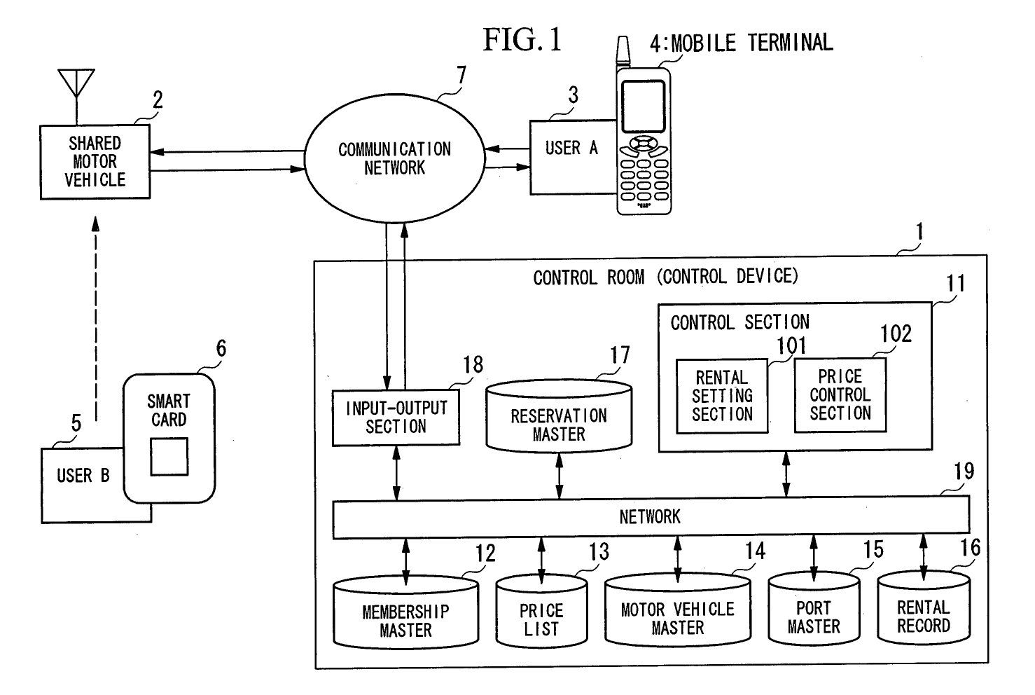

FIG. 1 is a block diagram for a first embodiment of the present invention.

In FIG. 1, a control center 1 is a control center which is provided with a controlling device for controlling the common usage of the shared motor vehicles 2, such as, making a reservation, allocating the motor vehicle, and billing a usage price for the motor vehicles 2 which are parked in the parking area which is called as a port so as to be used commonly by the users. The shared motor vehicles 2 are used in two methods such as a “reserved rental” form and a “non-reserved” form. In the “reserved rental”, a motor vehicle is reserved by designating information for specifying a motor vehicle such as a departing and arriving port, date, time, and a motor vehicle ID when the user A3 who is registered as a membership by the control center 1 make a reservation from a mobile terminal 4 to the control center 1. In the “non-reserved rental”, a vacant motor vehicle is used directly by a smart card 6 which is owned by a user B5 who is registered as a membership by the control center 1.

Also, a communication network 7 connects the mobile terminal 4 which is owned by the user A3, the control center 1, a shared motor vehicle 2, and a control center 1. In the communication network 7, information is transmitted and received via a wireless communication such as a WAP (Wireless Application Protocol) or a wired communication via internet and a public network.

Here, under the control center 1, more then 1 (one) motor vehicles 2 are controlled. Also, there may be any number of users such as A3 and B5.

Also, the mobile terminal 4 has a connecting function to a computer network such as the Internet and a public network via wireless communication. The mobile terminal 4 includes not only a mobile terminal such as a portable phone and a PHS (Personal Handyphone System) phone or a mobile communication terminal, but also a terminal which is connected to a wired communication. Furthermore, the mobile terminal 4 includes a terminal which has a connecting function to a simple computer network in the terminal which uses the above wired communication or wireless communication.

Also, the control center 1 comprises a controlling section 11, a membership master 12, a charge list 13, a motor vehicle list 14, a port master 15, a rental record 16, a reservation master 17, an inputting-outputting section 18, and a network 19.

The controlling section 11 executes a motor vehicle control program in a computer system which is provided with a CPU (Central Processing Unit) and controls an overall operations in the control center 1.

Also, in particular, the controlling section 11 includes a rental setting section 101 which controls a rental form of the shared motor vehicle 2, and a price controlling section 102 which controls a usage price of the shared motor vehicle 2. Here, the detail of the operations in the controlling section 11 are explained later.

The membership master 12 is a database for recording registration data for the users who are registered as a membership. In the membership master 12, information such as (1) a user ID, (2) address, and (3) a right of usage for each membership.

The charge list 13 is a database in which a pricing system for a usage of the shared motor vehicle 2 is recorded. In the charge list 13, information such as (1) a basic price, (2) a surcharge, and (3) overcharge and discount charge are recorded.

The motor vehicle master 14 is a database in which information for a condition of the shared motor vehicles for controlling the shared motor vehicles 2 is recorded. For the information for a condition of the shared motor vehicles, information such as (1) a motor vehicle number, (2) a type and equipments of motor vehicle, (3) parking position (parking port), and (4) condition are recorded for each shared motor vehicle.

The port master 15 is a database in which a condition regarding the port is recorded for controlling the shared motor vehicle 2. In the port master 15, for example, information such as (1) number of motor vehicles which are parked in the parking area, (2) a parking capacity, and (3) a motor vehicle number which is parked are recorded for each port.

The rental record 16 is a database in which a rental record of the shared motor vehicle 2 is recorded. For example, for such information for each individual user, (1) a user ID, (2) motor vehicle number (which is rented), (3) a rental time, (4) a return time, (5) a departing place, (6) a return place, (7) a driving distance, and (8) a used fuel amount are recorded.

The reservation master 17 is a database in which a reservation information is recorded for controlling the reservation of the motor vehicle for the user A3 in the “reserved rental”. In the reservation master 17, information such as (1) a departing port, (2) an arriving port, (3) a motor vehicle ID which are related to the user ID of the user A3, and a reservation status table which indicates excess and deficiency for the number of parked motor vehicles which are reserved for each port are recorded.

The inputting-outputting section 18 is an interface section for transmitting and receiving information regarding the rental data of the motor vehicle between the control center 1 and the mobile terminal 4 and a motor vehicle control data such as information for rental and return of the motor vehicle between the control center 1 and the shared motor vehicle 2. Here, the motor vehicle control data if transmitted and received directly between the control center 1 and the shared motor vehicle 2 via the wireless communication.

The network 19 forms a LAN (Local Area Network) for transmitting and receiving data. The network 19 connects the controlling section 11, the membership master 12, the charge list 13, the motor vehicle master 14, the port master 15, the rental record 16, the reservation master 17, and an inputting-outputting section 18 in the control center 1.

Next, the shared motor vehicle 2 which is used in the present embodiment is explained with reference to drawings.

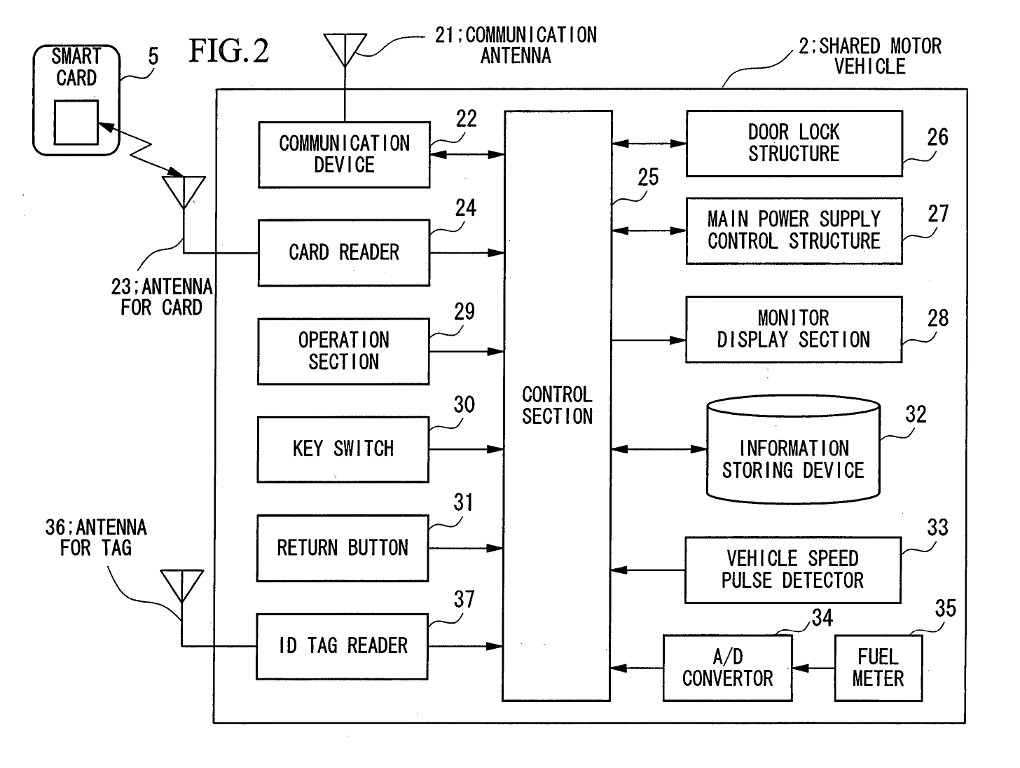

FIG. 2 is a block diagram showing a structure in the shared motor vehicle 2. In FIG. 2, the shared motor vehicle 2 comprises a communication antenna 21, a communicating device 22, an antenna 23 for card, a card reader 24, a controlling section 25, a door lock structure 26, a main power supply controlling structure 27, a monitor display section 28, an operating section 29, a key switch 30, a return button 31, an information storing device 32, a motor vehicle speed pulse detecting device 33, an A/D converter 34, a fuel meter 35, an antenna 36 for tag, an ID tag reader 37, and an LED display section 38.

The shared motor vehicle 2 is parked in a parking space, which is called a lot, for parking one motor vehicle in a parking area which is called a port. The shared motor vehicle 2 communicates with the control center 1 via the communicating device 22 which is connected to the communication antenna 21 so as to exchange various data.

When the user A3 or the user B5 holds, for example, a non-contacting readable rewritable smart card 6 to the antenna 23 for card which is disposed in the shared motor vehicle 2, the shared motor vehicle 2 notifies a signal which is read by the card reader 24 to the controlling section 25 which controls operations of the shared motor vehicle 2.

The controlling section 25 communicates with the control center by a wireless communication via the communicating device 22 and the communication antenna 21 and transmits to the control center 1 that the user requested a usage of the shared motor vehicle 2 by holding the smart card 6 and requests a permission for a rental of the motor vehicle.

Also, the information storing device 32 is formed by a ROM (Read Only Memory) and a RAM (Random Access Memory). The information storing device 32 stores an ID number for the motor vehicle which is allocated to each shared motor vehicle 2 in advance and stores an ID number and a PIN (Personal Identification Number) for the user which are inputted by the user temporarily. When the controlling section 25 transmits the ID number of the motor vehicle which is stored in the information storing device 32 and the ID number which is inputted by the user to the control center 1, and a permission for the rental of the shared motor vehicle 2 is issued to the user, the door lock structure 26 releases a door key according to an instruction by the control center 1 to which a rental of the motor vehicle is requested. Also, when a coincidence of the PIN is confirmed in the controlling section 25, the main power supply controlling structure 27 lets an ignition circuit be usable.

The user A3 or the user B5 inputs necessary items to the controlling section 25 from the operating section 29 according to instructions which are displayed on the motor vehicle display section 28 when the shared motor vehicle 2 is rented. The user A3 or the user B5 pushes the key switch 30 so as to turn of the ignition of the shared motor vehicle 2 so as to start the shared motor vehicle 2. Also, the user pushes a return button 31 in the port so as to perform a returning operation when the shared motor vehicle 2 is returned to the port.

Here, the above smart card 6 is an ID terminal which is provided with an IC including a processor which can perform a simple self-determination only by the card. In the above smart card 6, it is possible to read and rewrite the recorded ID number. In the present embodiment, any member can be used for the ID terminal which is used for notifying the ID number to the shared motor vehicle 2. That is, the ID terminal is not limited to those which work according to a non-contacting method or a contacting method; thus, a magnetic card, a portable telephone having a built-in IC chip in which ID number can be read can be used for the ID terminal as long as a reading device in the shared motor vehicle 2 can handle the ID number.

Also, the motor vehicle speed pulse signal which indicates a driving condition of the shared motor vehicle 2 is notified to the controlling section 25 from the motor vehicle speed pulse detecting device 33 while the shared motor vehicle 2 is driving. Furthermore, a fuel meter 35 is connected to the controlling section 25 via the AID converter 34 by which the controlling section 25 acknowledges a consumption of the fuel.

Here, detail operations for the user to rent the shared motor vehicle 2 are explained later.

Also, the shared motor vehicle 2 which is parked in the port identifies the lot in the port by the antenna 36 for tag and the ID tag reader 37. Also, the LED display section 38 is disposed in a position for the user to see from the outside of the shared motor vehicle 2 so as to display control conditions of the shared motor vehicle 2 such as “Reserved”, “Available”, “Not Available” by a display such as a colored display or a character. Here, any member can be used for the LED display section 38 as long as the control condition of the shared motor vehicle 2 can be displayed to the user.

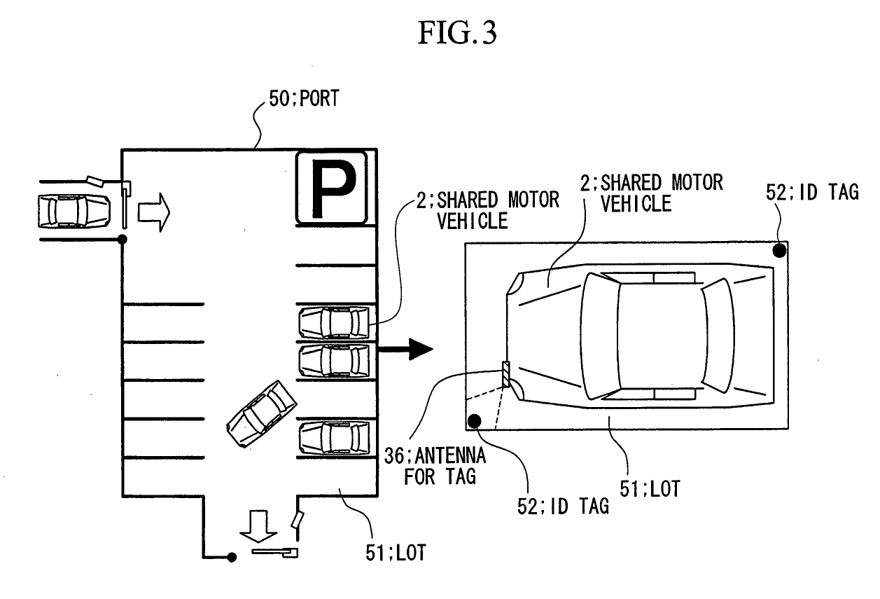

Here, a tag is explained with reference to FIG. 3. As shown in FIG. 3, a plurality of lots 51 are disposed in the port 50 for parking the shared motor vehicles 2. ID tags 52 as devices for transmitting the ID number which is allocated to the port 50 and the lot 51 respectively are disposed on each lot 51.

The ID tag 52 exchanges an original ID number with the antenna 36 for tag for each port 50 and lot 51 according to a method such as an electromagnetic coupling method, a microwave method, an electrostatic coupling method, or an optical transmitting method. The shared motor vehicle 2 acknowledges positions for the port and the lot where the shared motor vehicle 2 is parked by reading the signal which is received by the antenna 36 for tag by the ID tag reader 37. Here, as shown in FIG. 3, two ID tags 52 are disposed diagonally in the lot 51 so as to correspond to a front stop and a rear stop of the shared motor vehicle 2. Antenna 36 for tag is disposed a front corner near the ID tag 52 or a rear corner (a left front corner in FIG. 3).

A structure for the shared motor vehicle 2 to acknowledge the positions of the port and the lot where the shared motor vehicle 2 is parked is not limited to the ID tag 52. That is, it may be acceptable if a transmitting-receiving device which is used for an ETC (Electronic Toll Collection) system or a position detector which uses a GPS (Global Positioning System) is used for such a structure.

Next, motor vehicle rental operations in the motor vehicle sharing system according to the present embodiment are explained with reference to drawings below.

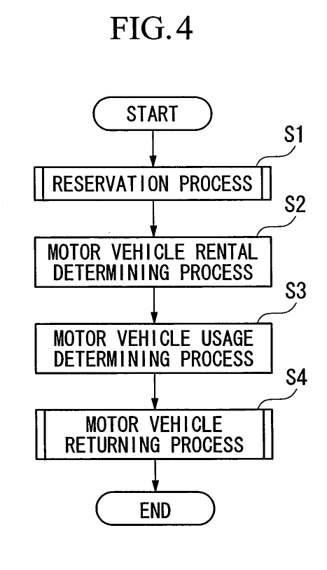

FIG. 4 is a flow chart showing overall processes in the motor vehicle sharing system.

First, when the user A3 desires making a reservation for a shared motor vehicle 2, the user A3 accesses the control center 1 via the communication network 7 such as Internet from the portable terminal 4 so as to perform processes for making a reservation (Step S1). After a right to use the shared motor vehicle 2 is obtained, the user A3 goes to a port where the shared motor vehicle 2 is actually parked and holds the smart card 6 to the antenna 23 for card on the corresponding shared motor vehicle 2 so as to provide the user ID of the user.

Also, when the user B5 uses the shared motor vehicle 2 without a reservation, the control center 1 does not perform the reservation process (step S1). Instead of that, the user B5 goes to the port directly where the shared motor vehicle 2 is parked and holds the smart card 6 to the antenna 23 for card on the shared motor vehicle 2 which the user actually desires using so as to provide the user ID of the user.

The shared motor vehicle 2 to which the user ID is provided and the control center 1 perform a motor vehicle rental determination process and determine whether or not the user may enter (access) the motor vehicle (step S2).

Here, in the motor vehicle rental determination process, the user ID which is given to the user is confirmed. The controlling section 25 in the shared motor vehicle 2 reads the user ID which is recorded in the smart card 6 by the card reader 24 when the user A3 or the user B5 accesses the shared motor vehicle 2 by the smart card 6 so as to inquire to the control center 1 via the communicating device 22 and the communication antenna 21.

On the other hand, the controlling section 11 in the control center 1, a membership list in the membership master 12 is retrieved according to the received user ID when the inquiry for the user ID comes from the shared motor vehicle 2. If the inquired user ID indicates an authorized user, that is, it is not a case of a double-booked rental, the controlling section 11 in the control center 1 transmits a rental permission and PIN to the shared motor vehicle 2 via the inputting-outputting section 18.

When the user is permitted to enter the motor vehicle according to the motor vehicle rental determination process, the user inputs the PIN which is allocated to the user from the operating section 29 in the shared motor vehicle 2; thus, the shared motor vehicle 2 performs the motor vehicle usage determination process (step S3).

Here, in the motor vehicle usage determination process, the PIN which is allocated to the user is confirmed. When the user A3 or the user B5 inputs the PIN from the operating section 29, the controlling section 25 in the shared motor vehicle 2 determines whether or not the inputted PIN and the PIN which is allocated to the user A3 or the user B5 in advance so as to be transmitted from the control center 1 coincide. As a result of the determination, if the PINs coincide, the controlling section 25 in the shared motor vehicle 2 outputs an engine start permission signal to the main power supply controlling structure 27; therefore, the user starts the engine in the shared motor vehicle 2 by the key switch 30 and starts using the motor vehicle. When the user who is permitted to use the shared motor vehicle 2 by the motor vehicle usage determination process completes using the shared motor vehicle 2, the user performs a motor vehicle return process (step S4) for the shared motor vehicle 2 to the port, the control center 1 obtains a return information for billing a usage price. Thus, operations of the motor vehicle sharing system of the present embodiment completes. Here, the detail of the motor vehicle return process is explained later.

Next, detail of the above reservation process is explained with reference to drawings below.

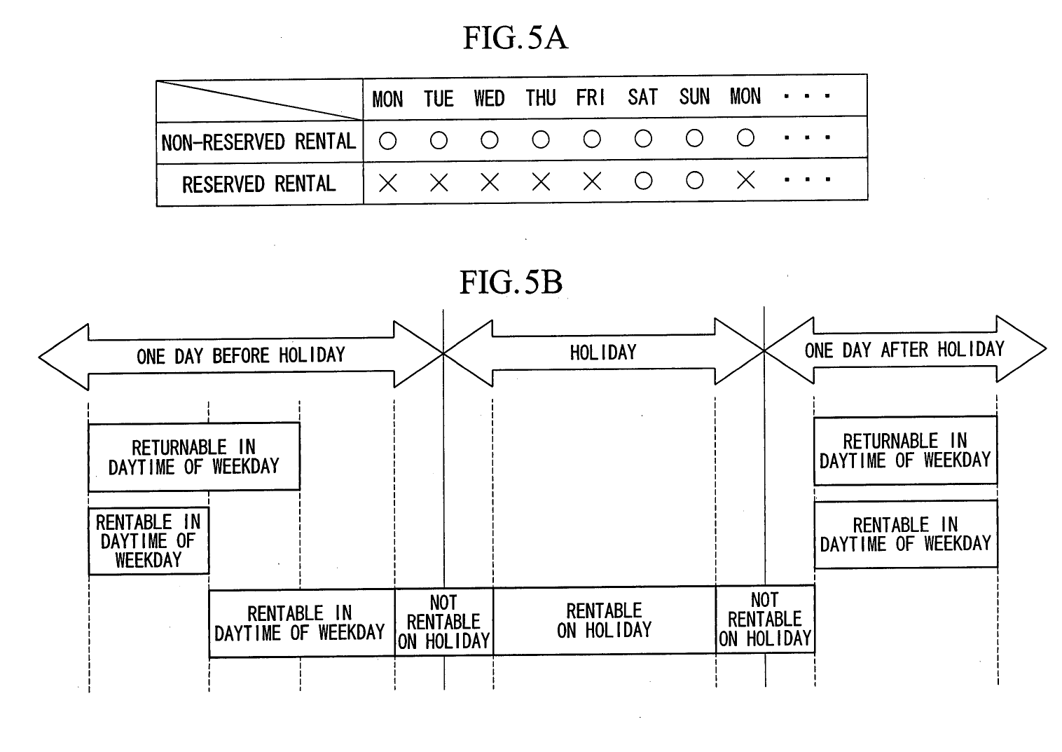

FIGS. 5A and 5B show an example for dates in which a reservation is available for the shared motor vehicle 2.

In the motor vehicle sharing system according to the present embodiment, as shown in FIG. 5, availability for whether or not the “reserved rental” is possible is designated according to a date in which the shared motor vehicle 2 is used; such an availability is recorded in the reservation master 17. For example, in FIG. 5(a), from Monday through Friday in which a short-time-usage is frequent such as shopping to a neighborhood, only a “non-reserved rental” in which the motor vehicle can be rented without a reservation for a short period of time easily is permitted. Also, on Saturday, Sunday, and a holiday in which the motor vehicle is often used according to a planned schedule such as a travel, a “reserved rental” can be possible compatibly. Also, as shown in FIG. 5(b), the weekday “non-reserved rental” is stopped earlier in a day before holiday so as to prepare the shared motor vehicle 2 which is used for the “reserved rental” for the holiday by any means. Only the returning of the motor vehicle is permitted in such a time in a day before holiday.

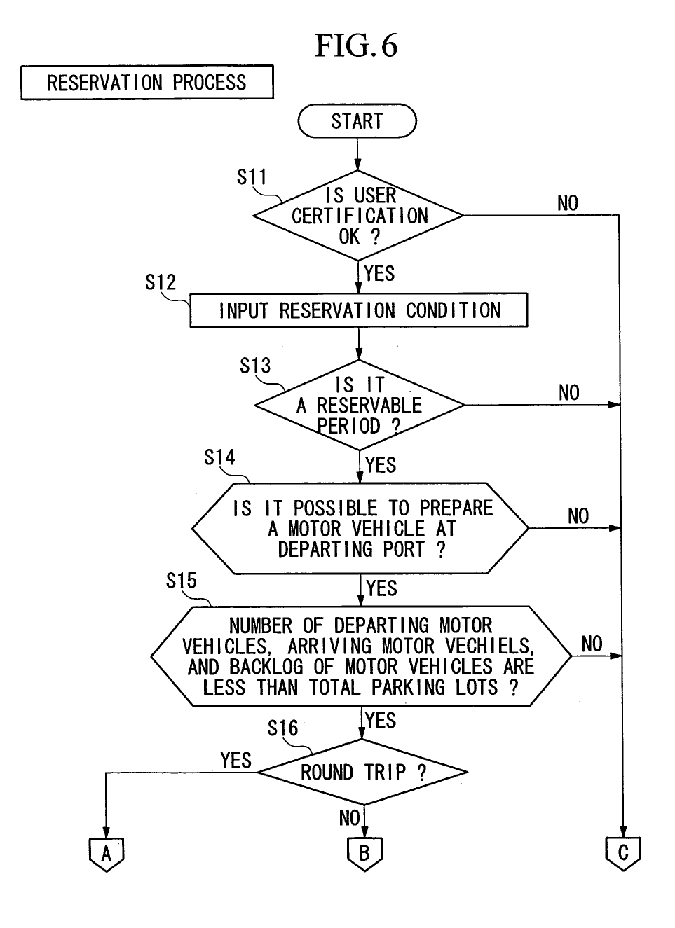

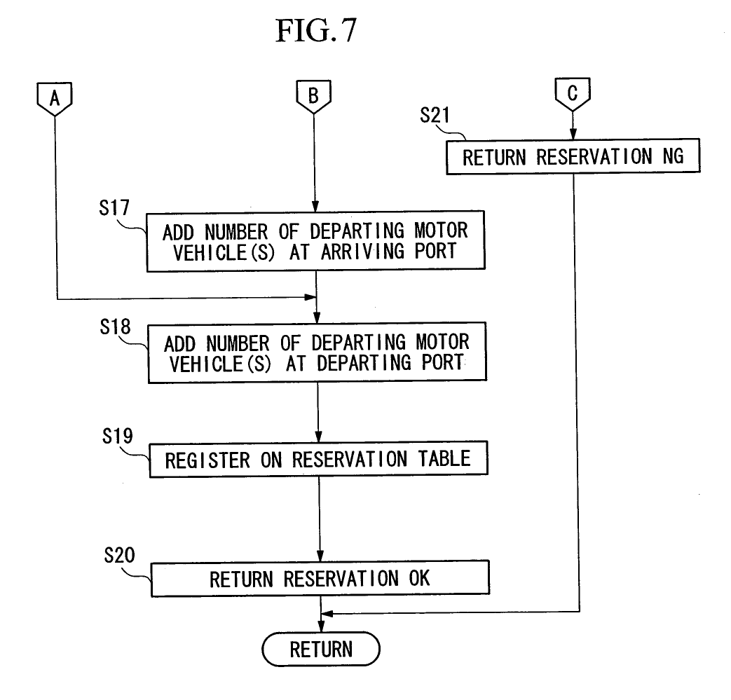

Detail of reservation processing operations in the motor vehicle sharing system in which a period in which a reservation can be made is set are explained using flow charts shown in FIGS. 6 and 7.

First, when the user A3 uses the portable terminal 4 so as to access the control center 1 via the communication network 7, a rental setting section 101 which is included in the controlling section 11 in the control center 1 requests to the user A3 for a permission for the user via the portable terminal 4 so as to determine whether or not the result of such a request is normal (step S1).

When the result of the user permission is normal in the step S11 (YES in the step S11), the rental setting section 101 lets the user A3 input a reservation condition via the portable terminal 4 (step S12). Here, the reservation condition is used for specifying a shared motor vehicle 2 which is supposed to be rented such as a departing port, an arriving port, a usage date, used time, preferred type of the motor vehicle, equipments, and an motor vehicle ID.

Next, the rental setting section 101 determines whether or not it is possible to make a reservation on the designated date with reference to the reservation master 17 (step S13).

In the step S13, if it is possible to make a reservation on the designated date (YES in the step S13), whether or not it is possible to prepare a motor vehicle in the departing port is determined (step S14).

In the step S14, if it is possible to prepare the motor vehicle in the departing port (YES in the step S14), it is determined whether or not a total of departing motor vehicles, arriving motor vehicles, and backlog in the arriving port exceeds a total parking lots (Step S15).

In the step S15, if the total of departing motor vehicles, arriving motor vehicles, and backlog in the arriving port is smaller than the total parking lots (YES in the step S15), it is determined whether or not a preferred usage of the shared motor vehicle 2 is a round trip (the departing port and the arriving port are the same each other) (Step S16).

In the step S16, if the preferred usage of the shared motor vehicle 2 is not a round trip (NO in the step S16), a motor vehicle is added to the arriving motor vehicles in the arriving port in a reservation condition table which is recorded in the reservation master 17 (Step S17). Next, a motor vehicle is added to the departing motor vehicles in the departing port (Step S18).

Consequently, the rental setting section 101 records the above reservation condition for a reservation contents in the reservation table in the reservation master 17 (Step S19) so as to complete the reservation processing operations by notifying a message for reservation OK to the user A3 via the portable terminal 4 (Step S20).

On the other hand, the rental setting section 101 completes the reservation processing operations by notifying a message for reservation NG to the user A3 via the portable terminal 4 when any of conditions below is satisfied (Step S21) such as (1) when a result of the user permission is abnormal (NO in the step S11), (2) when the designated date indicates a period in which it is not possible to make a reservation (NO in the step S13), (3) when it is not possible to prepare a motor vehicle in the departing port (NO in the step S14), and (4) when the total of departing motor vehicles, arriving motor vehicles, and backlog in the arriving port exceeds the total parking lots (NO in the step S15).

Next, detail of the motor vehicle return processing operation in the motor vehicle sharing system in which the above period in which the reservation can be made is explained with reference to drawings further below.

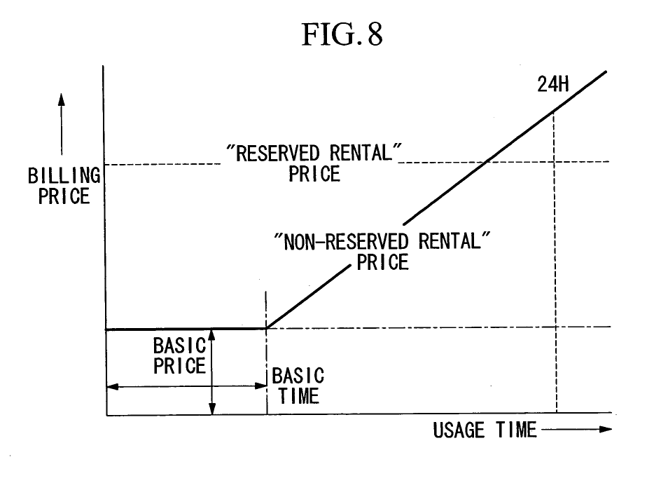

FIG. 8 shows a price system which is recorded in the charge list 13 in the motor vehicle sharing system according to the present embodiment. In the present embodiment, a price of the “non-reserved rental” in which the motor vehicle is used on an hourly basis and a price of the “reserved rental” in which the motor vehicle is used on a daily basis are billed separately as shown in FIG. 8.

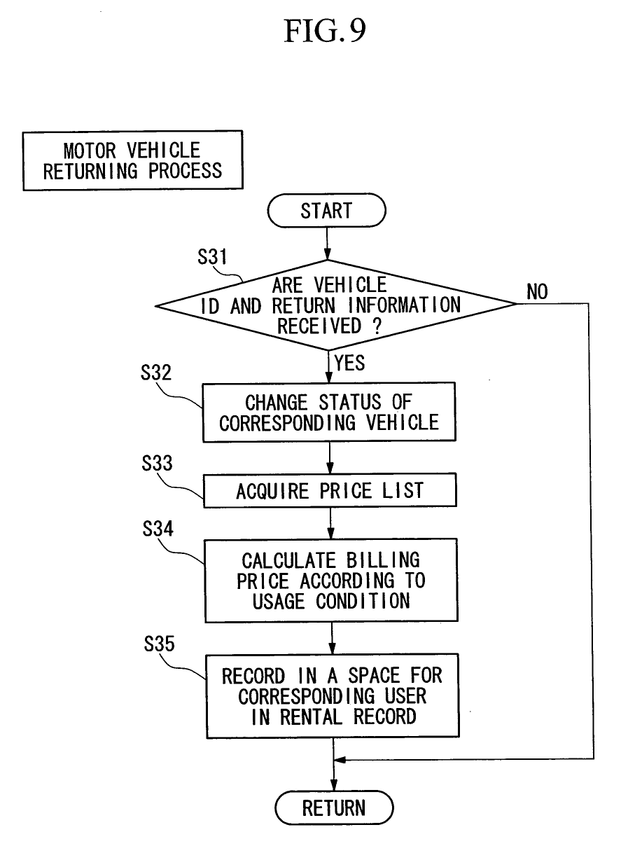

The motor vehicle return processing operation in the motor vehicle sharing system in which the above price system is set is explained with reference to a flow chart shown in FIG. 9. First, the controlling section 11 in the control center 1 determines whether or not the motor vehicle ID and the return information are received from the shared motor vehicle 2 (Step S31) when the user A3 or the user B5 completes the usage of the shared motor vehicle 2 and pushes the return button 31. Here, the return information indicates a return time, a driving distance, and a returned fuel amount which are necessary for calculating a usage price of the shared motor vehicle 2.

In the step S31, when-the motor vehicle ID and the return information are received from the shared motor vehicle 2 (YES in the step S31), the controlling section 11 changes a status of the corresponding shared motor vehicle 2 so as to be able to be rented (step S32).

Next, a price controlling section 102 in the controlling section 11 obtains a price setting information from the charge list 13 (step S33).

After the price setting information is obtained, the price controlling section 102 obtains a usage condition of the shared motor vehicle 2 by the user from the return information so as to calculate the usage price according to the usage condition (step S34).

After the usage price is calculated according to the usage condition, the price controlling section 102 records a usage price in a space for the corresponding user in the rental record 16 (step S35). Here, the recorded usage price is adjusted through a financial corporation which is designated by the user later.

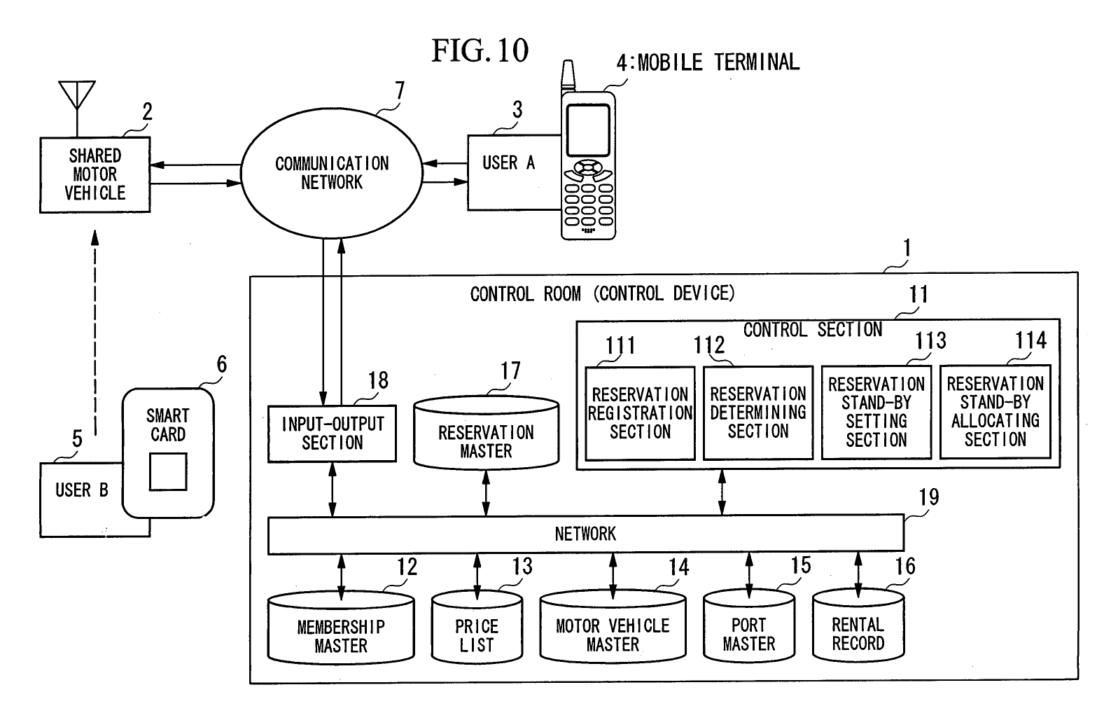

Next, a second embodiment of the present invention is explained with reference to FIGS. 10 to 14. Hereinafter, the same reference numerals are applied to corresponding members as shown in the first embodiment so as to omit the repeated explanation thereof.

FIG. 10 is a block diagram for a structure of the second embodiment. In the present embodiment, in particular, the controlling section 11 includes a reservation registering section 111 which controls a reservation allocation in the shared motor vehicle 2, a reservation determining section 112 which determines stopping the reservation registration process, a stand-by reservation setting section 113 which controls the non-set reservation for a stand-by reservation, and a stand-by reservation allocating section 114 which makes a reservation for the standing-by user when the reservation is reopened so as to notify the user of the reservation. Here, detail of operation in the controlling section 11 in the present embodiment is explained later.

Also, in the reservation master 17 which is a database in which a reservation information for controlling the reservation for the “reserved rental” of the motor vehicle by the user A3 is recorded, information which is related to the user ID of the user A3 such as (1) a departing port, (2) an arriving port, (3) a motor vehicle ID are recorded. Furthermore, the reservation table in which information for the user A3 to stand by a reservation is recorded, and a reservation condition table which indicates excess or lack of the number of the parked motor vehicle which is reserved for each port are recorded in the reservation master 17.

The motor vehicle rental operation in the motor vehicle sharing system according to the present embodiment is performed according to the processes shown as the steps S1 to S4 shown in the flow chart in the FIG. 4 as similar to the first embodiment. When the control center 1 obtains a return information for billing a usage price, the operations in the motor vehicle sharing system according to the present embodiment is completed. Here, the return information indicates a return time, a driving distance, and a returned fuel amount which are necessary for calculating a usage price of the shared motor vehicle 2.

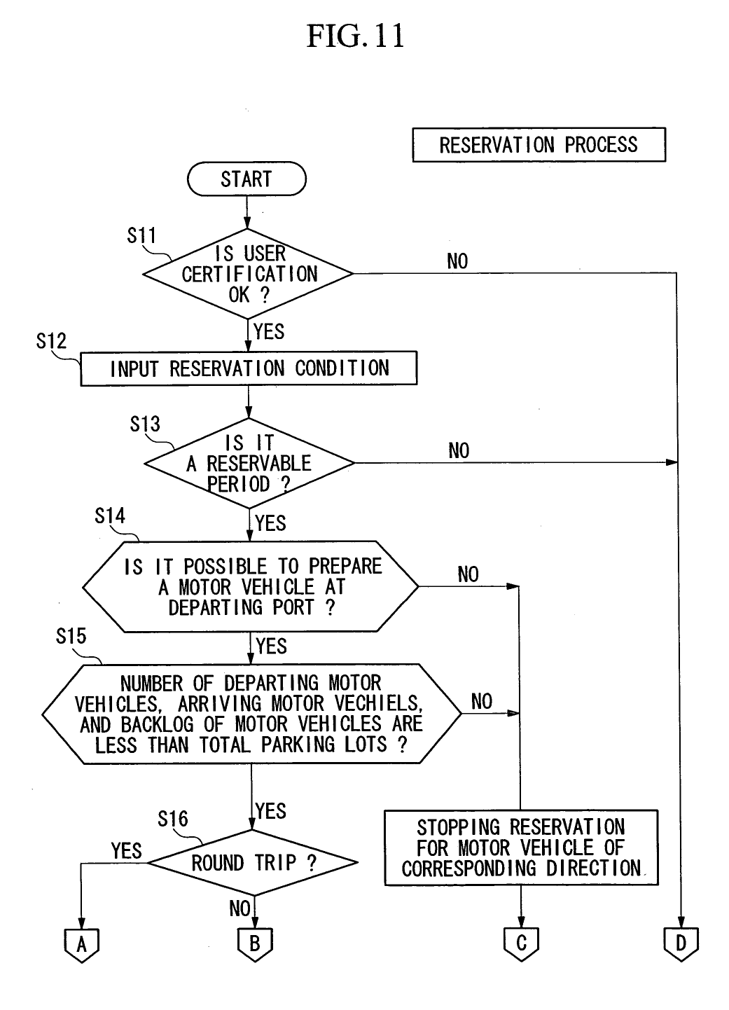

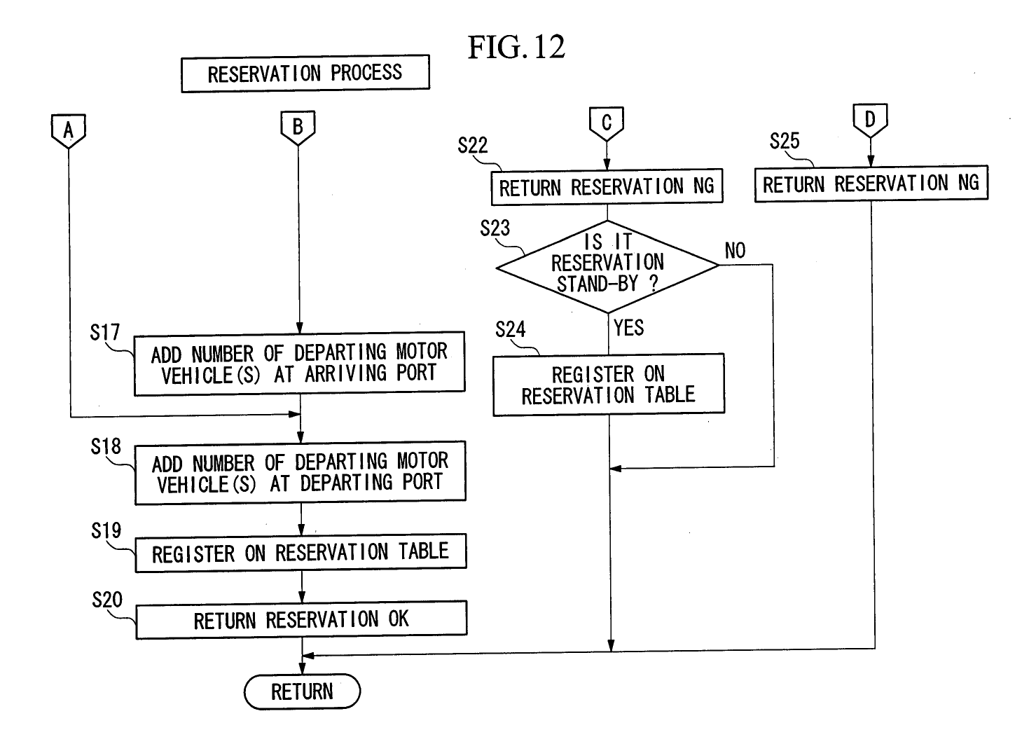

Next, detail of the above reservation process is explained with reference to a flow charts shown in FIGS. 11 and 12.

First, when the user A3 uses the portable terminal 4 so as to access the control center 1 via the communication network 7, a reservation registering section 111 which is included in the controlling section 11 in the control center 1 requests to the user A3 for a permission for the user via the portable terminal 4 so as to determine whether or not the result of such a request is normal (step S11).

When the result of the user permission is normal in the step S11 (YES in the step S11), the reservation registering section 111 lets the user A3 input a reservation condition via the portable terminal 4 (step S12). Here, the reservation condition is used for specifying a shared motor vehicle 2 which is supposed to be rented such as a departing port, an arriving port, a usage date, used time, preferred type of the motor vehicle, equipments, and an motor vehicle ID.

Next, the reservation registering section 111 determines whether or not a reservation registration for a usage of the motor vehicle in a direction from the required departing port to the arriving port is accepted (step S13).

In the step S13, the reservation registration for a usage of the motor vehicle in a direction from the required departing port to the arriving port is accepted (YES in the step S13), it is determined whether or not it is possible to prepare a motor vehicle in the departing port (step S14).

In the step S14, if it is possible to prepare the motor vehicle in the departing port (YES in the step S14), it is determined whether or not a total of departing motor vehicles, arriving motor vehicles, and backlog in the arriving port exceeds a total parking lots (Step S15).

In the step S15, if the total of departing motor vehicles, arriving motor vehicles, and backlog in the arriving port is smaller than the total parking lots (YES in the step S15), it is determined whether or not a preferred usage of the shared motor vehicle 2 is a round trip (the departing port and the arriving port are the same each other) (Step S16).

In the step S16, if the preferred usage of the shared motor vehicle 2 is not a round trip (NO in the step S16), a motor vehicle is added to the arriving motor vehicles in the arriving port in a reservation condition table which is recorded in the reservation master 17 (Step S17). Next, a motor vehicle is added to the departing motor vehicles in the departing port (Step S18).

Consequently, the reservation registering section 111 records the above reservation condition for a reservation contents in the reservation table in the reservation master 17 (Step S19) so as to complete the reservation processing operations by notifying a message for reservation OK to the user A3 via the portable terminal 4 (Step S20).

On the other hand, a reservation determining section 112 which is included in the controlling section 11 stops the reservation registration for a usage of the motor vehicle in the corresponding direction which is requested by the user A3 (step S21) and notifies a message of reservation NG to the user A3 via the portable terminal 4 (step S22) when any of the following conditions is satisfied such as (1) when it is not possible to prepare a motor vehicle in the departing port (NO in the step S14), (2) the total of departing motor vehicles, arriving motor vehicles, and backlog in the arriving port exceeds the total parking lots (NO in the step S15).

Also, “when the total of departing motor vehicles, arriving motor vehicles, and backlog in the arriving port exceeds the total parking lots”, the “non-reserved rental” of the motor vehicle in which the port is an arriving port is stopped.

Next, after the message of reservation NG is notified to the user A3 via the portable terminal 4, a stand-by reservation setting section 113 which is included in the controlling section 11 inquires to the user A3 for whether or not standing by a reservation via the portable terminal 4 (step S23).

In the step S23, if the user A3 desires standing by a reservation (YES in the step S23), an inputted reservation condition for a stand-by reservation data is recorded in the reservation-standing-by table in the reservation master 17 in an order such that the reservation occurs; thus, the reservation processing operation is completed (step S24).

On the other hand, if the user A3 does not desire standing by a reservation (NO in the step S23), the reservation processing operation is completed while no particular operation is performed.

Also, if the result of the user permission in the step 11 indicates abnormal (NO in the step S11), or if the reservation registration which is requested in the step S13 for a usage of the motor vehicle in a direction from the departing port to the arriving port is not accepted (NO in the step S13), a message of the reservation NG is notified to the user A3 via the portable terminal 4 (step S25).

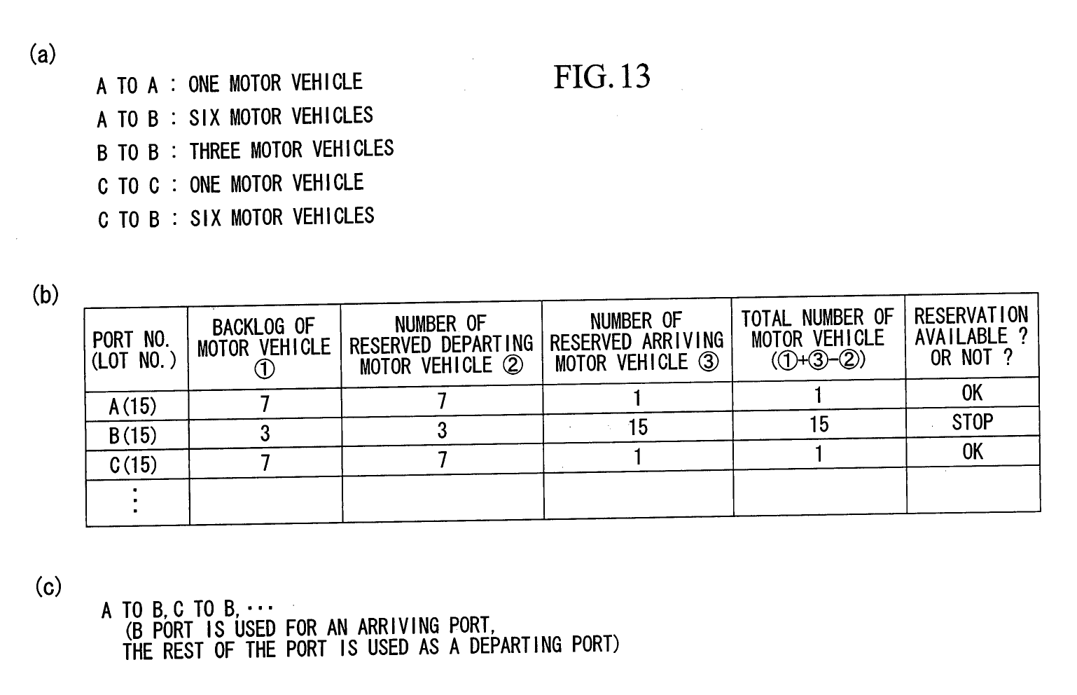

FIG. 13 shows an example for whether or not it is possible to control the number of the motor vehicles in the port and make a reservation in the motor vehicle sharing system in the present embodiment by the above reservation processing operation.

Contents in the reservation which is currently inputted is shown in FIG. 13(a). For example, in the motor vehicle sharing system which is provided with ports A, B, . . . in which the number of the parking lots are 15 (fifteen), it is assumed that a reservation such as

(1) A to A: 1 (one) motor vehicle

(2) A to B: 6 (six) motor vehicles

(3) B to B: 3 (three) motor vehicles

(4) C to C: 1 (one) motor vehicle

(5) C to B: 6 (six) motor vehicles is received.

In this case, as shown in FIG. 13(b), if the present backlog of the motor vehicle in each port is as follows,

(1) A port: 7 (seven) motor vehicles

(2) B port: 3 (three) motor vehicles

(3) C port: 7 (seven) motor vehicles

a “total motor vehicles=backlog of the motor vehicles+reserved arriving motor vehicles−reserved departing motor vehicles” in each port becomes as follows.

(1) A port: 1 (one) motor vehicle

(2) B port: 15 (fifteen) motor vehicles

(3) C port: 1 (one) motor vehicle

According to the above explanation, it is understood that the lots for parking the shared motor vehicles 2 are filled in the B port; therefore, it is not possible to park any more shared motor vehicles 2.

Therefore, the reservation for a usage of the motor vehicle in which a departing port is other than the B port and an arriving port is the B port such as “A to A” and “C to B” shown in FIG. 13(c) is stopped. Furthermore, the reservation in a stopped usage direction is re-started in a case in which the port can afford lots for parking the shared motor vehicles 2 such as a case in which the user B5 uses the shared motor vehicle 2 by the “non-reserved rental” or the shared motor vehicle 2 is moved to a maintenance plant for restoring the motor vehicle.

Next, a stand-by reservation allocating operation is explained with reference to drawings as follows in which the stopped reservation is restarted (released) and the motor vehicle is allocated to the user A3 preferentially who is recorded in the stand-by reservation table in the above step S24.

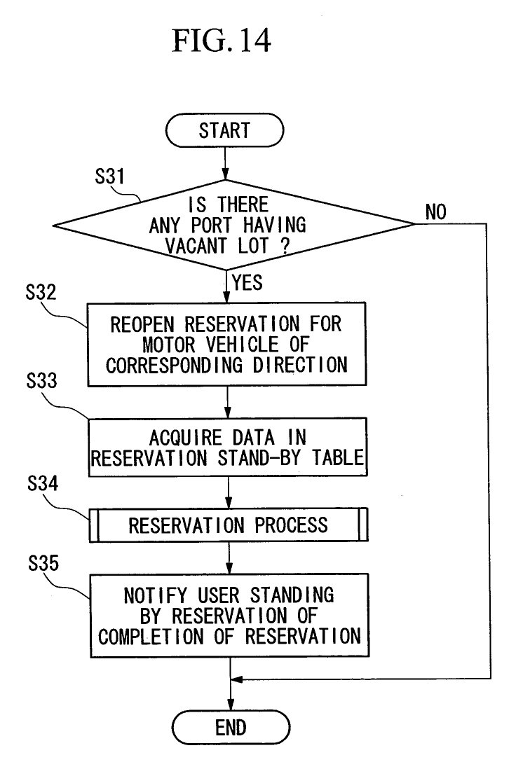

FIG. 14 is a flow chart showing the stand-by reservation allocating operation. In the reservation allocating operation, first, the stand-by reservation allocating section 114 which is included in the controlling section 11 retrieves, for example, a port which can afford lots for parking the shared motor vehicles 2 according to the reservation condition table in the reservation master 17 periodically (step S31). If there is a port which can afford lots for parking the shared motor vehicles 2 (YES in the step S31), a usage for a motor vehicle and a reservation for a motor vehicle in a direction in which the corresponding port is an arriving port are restarted (step S32).

Next, information for the user A3 is obtained from the stand-by reservation allocating table in the reservation master 17 (step S33) so as to perform the reservation process which is explained with reference to the above FIGS. 12 and 13 (step S34).

In the step S34, when the motor vehicle is allocated to the user A3 who stands by a reservation, a reservation completion message is transmitted to the user A3 and the stand-by reservation allocating operation is completed (step S35).

On the other hand, in the step S31, if there is not a port which can afford lots for parking the shared motor vehicles 2 (NO in the step S31), the reservation processing operation is completed while no particular operation is performed.

Here, it is acceptable even if the stand-by reservation allocating operation is not performed periodically unless an information storage capacity in the stand-by reservation table is filled, or a preferred usage date comes while a reservation is stood by before the stand-by reservation allocating operation is performed.

Also, if the preferred usage date comes while a reservation is stood by even though the stand-by reservation allocating operation is performed, a message of the reservation NG is transmitted to the user A3, and the stand-by reservation data is cancelled.

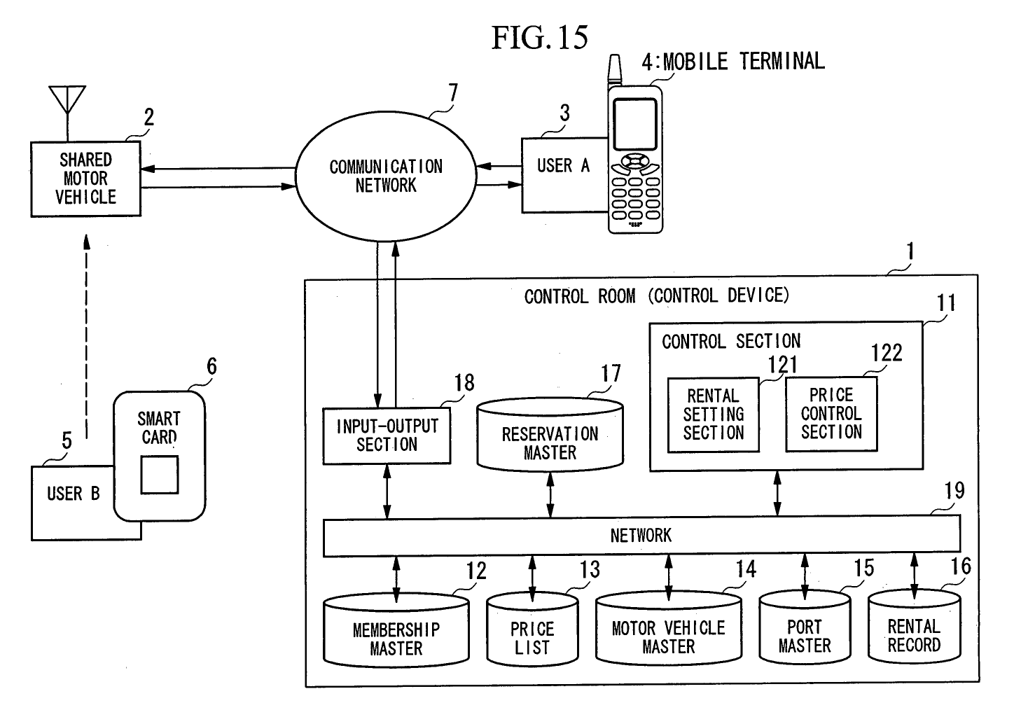

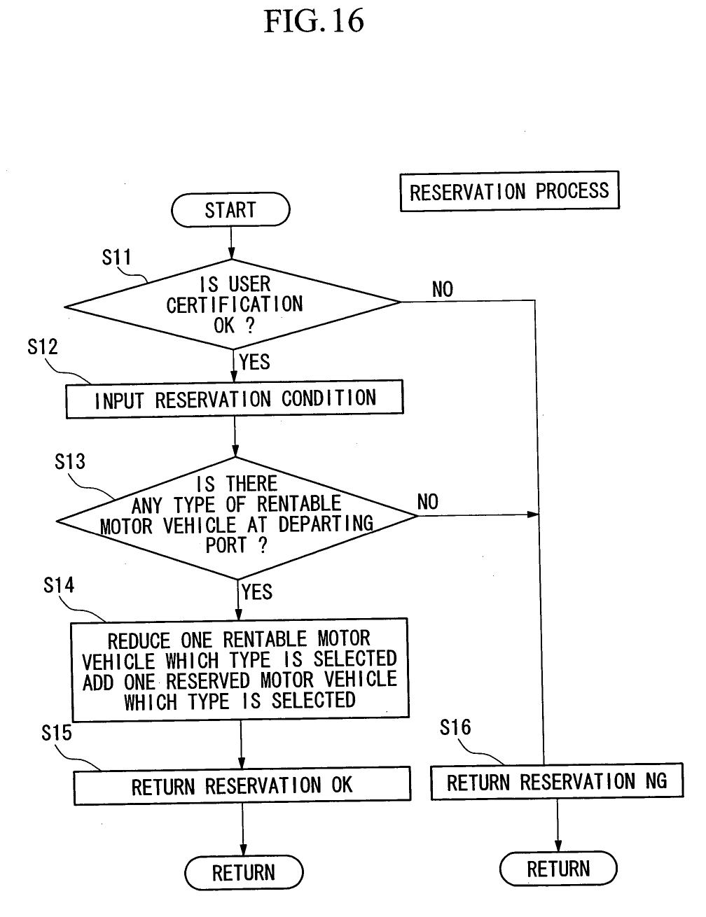

Next, a third embodiment of the present invention is explained with reference to FIGS. 15 to 19. Hereinafter, the same reference numerals are applied to corresponding members as shown in the first embodiment so as to omit the repeated explanation thereof.

FIG. 15 is a block diagram showing a structure of the third embodiment. In the present embodiment, the controlling section 11 includes a reservation registering section 121 which controls a reservation allocation of the shared motor vehicle 2 and a rental section 122 which makes decision for a motor vehicle rental while controlling a difference of motor vehicles such as a type of the motor vehicle between a motor vehicle to which a reservation is allocated and a motor vehicle which is actually rented. Here, detail of the operation in the controlling section 11 in the present embodiment is explained later.

Also, information for each of shared motor vehicle such as (1) motor vehicle number, (2) motor vehicle type information such as type of motor vehicle, equipment, colors, etc., (3) parking position (parking port), and (4) condition are recorded in the motor vehicle master 14 which is a database in which conditions for each shared motor vehicle is recorded for controlling the shared motor vehicle 2 in the present embodiment such that the motor vehicle may be allocated for a user to use easily. Also, information such as (1) a departing port, (2) an arriving port, and (3) type of motor vehicle which are related to the user ID for the user A3 are included in the reservation master 17 which is a database in which a reservation information is recorded for controlling a reservation for a motor vehicle for a user of “reserved rental”. A stand-by reservation table which records information for a case in which the user A3 stands by a reservation, and furthermore, a reservation condition table which indicates an excess or lack of reserved parked motor vehicles are recorded for each port are recorded in the reservation master 17. Thus, when the user A3 who is registered as a membership makes a reservation to the control center 1 from the portable terminal 4, the “reserved rental” operation can be started in which information such as a type of motor vehicle for specifying the motor vehicle is designated so as to obtain the motor vehicle.

The motor vehicle rental operation in the motor vehicle sharing system according to the present embodiment is performed according to the processes shown as the steps S1 to S4 shown in the flow chart in the FIG. 4 as similar to the first embodiment. When the control center 1 obtains a return information for billing a usage price, the operations in the motor vehicle sharing system according to the present embodiment is completed. Here, the return information indicates a return time, a driving distance, and a returned fuel amount which are necessary for calculating a usage price of the shared motor vehicle 2.

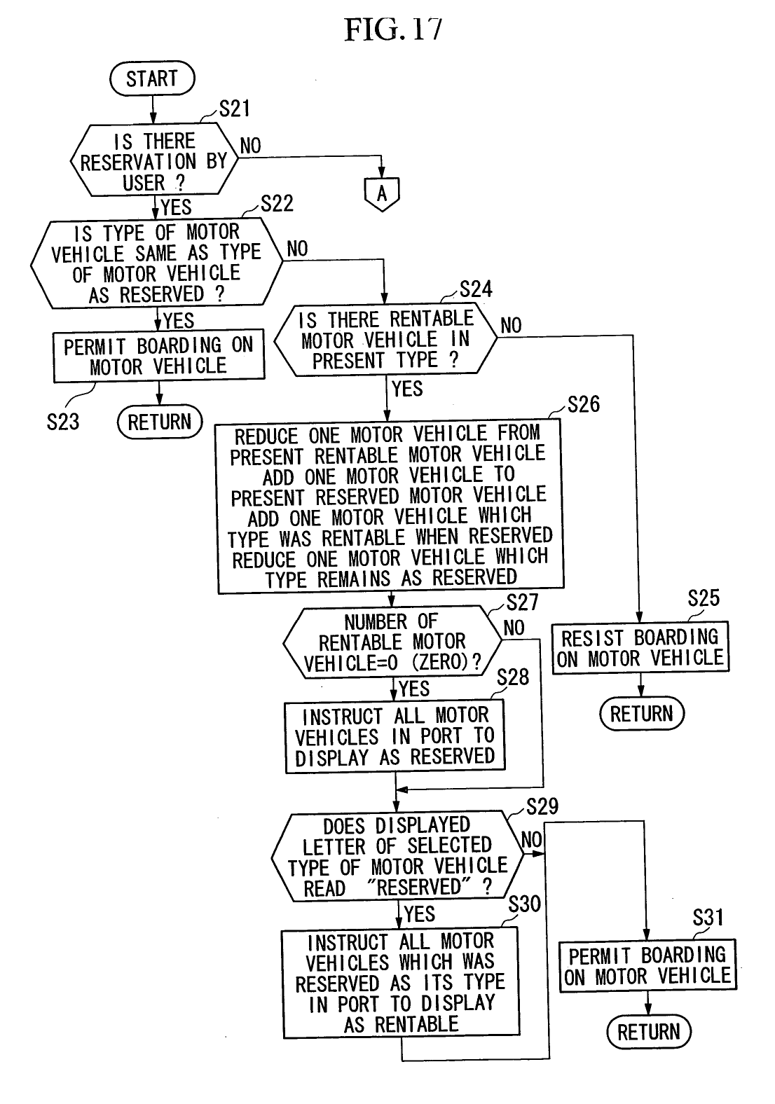

Next, detail of the above reservation process is explained with reference to a flow charts shown in FIG. 17.

First, when the user A3 uses the portable terminal 4 so as to access the control center 1 via the communication network 7, a reservation registering section 121 which is included in the controlling section 11 in the control center 1 requests to the user A3 for a permission for the user via the portable terminal 4 so as to determine whether or not the result of such a request is normal (step S11).

When the result of the user permission is normal in the step S11 (YES in the step S11), the reservation registering section 121 lets the user A3 input a reservation condition via the portable terminal 4 (step S12). Here, the reservation condition is used for specifying a shared motor vehicle 2 which is supposed to be rented such as a departing port, an arriving port, a usage date, used time, and a preferred model of the motor vehicle. Here, the model of the motor vehicle indicates a classification for specifying a motor vehicle such as type of the motor vehicle (type of chassis) and an engine, a transmission (such as AT/MT), a driving method such as two-wheel-driving or four-wheel-driving, equipments such as a sunroof, colors of the motor vehicle.

Next, the reservation registration processing section 121 determines whether or not a motor vehicle is prepared in a departing port (step S13).

In the step S13, if it is possible to prepare a motor vehicle in the departing port (YES in the step S13), a selected motor vehicle available to be used is reduced and a reserved motor vehicle is added in the corresponding port in the reservation condition table which is recorded in the reservation master 17 (step S14).

Also, when a number of selected types of motor vehicles available to be used in the departing port is calculated on the day for which the reservation has been made so as to determine whether or not the number of motor vehicle available to be used is 0 (zero), if the number of motor vehicle available to be used 0 (zero), an instruction for displaying an indication of “Reserved” on an LED display sections 38 on all the selected model of motor vehicles which are parked in the departing port is issued.

Consequently, the reservation registering section 121 records the above reservation conditions for contents of a reservation in the reservation table in the reservation master 17 and notifies the user A3 that the reservation is OK via the portable terminal 4, and completes the reservation processing operation (step S15).

On the other hand, in the step S11, if a result of the user permission is abnormal (NO in the step S11), or if it is not possible to prepare a motor vehicle in the departing port (NO in the step S13), the reservation registering section 121 does not record the contents of the reservation, but instead, notifies the user A3 of the message that the reservation is NG via the portable terminal 4; thus, the reservation processing operation is completed (step S16).

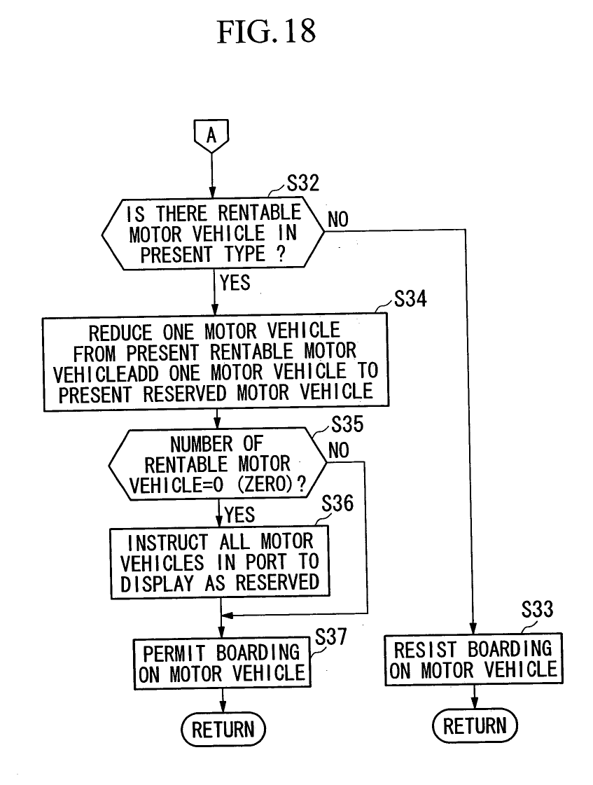

Next, detail of the above motor vehicle rental determining process is explained with reference to flow charts shown in FIGS. 18 and 19.

First, the rental section 122 which is included in the controlling section in the control center 1 determines whether or not the reservation information of the user is recorded in the reservation master 17 according to the user ID of the user (step S21) when the shared motor vehicle 2 of which usage is requested by the user A3 or the user B5 requests transmits the user ID of the user and requests the motor vehicle rental determining process.

In the step S21, if the reservation information of the user is recorded (YES in the step S21), it is determined whether or not a model (present model) of the shared motor vehicle 2 of which usage is requested is the same as the reserved model (step S22).

In the step S22, if a present model of the shared motor vehicle 2 of which usage is requested is the same as the reserved model (YES in the step S22), it is permitted that the user may enter the present model of the motor vehicle. Also, the rental section 122 transmits a rental permission and the PIN to the shared motor vehicle 2 via the inputting-outputting section 18; thus, the motor vehicle rental determining process is completed (step S23).

Also, in the step S22, if a present model of the shared motor vehicle 2 of which usage is requested is not the same as the reserved model (NO in the step S22), the rental section 122 determines whether or not there is a motor vehicle of present model which can be used with reference to the reservation condition table which is recorded in the reservation master 17 (step S24).

If there is not a motor vehicle of the present model which can be used in the step S24 (NO in the step S24), the rental section 122 refuses to let the user enters into the motor vehicle of the present model; thus, the motor vehicle determining process is completed (step S25).

Also, in the step S24, if there is a motor vehicle of the present model which can be used (YES in the step S24), the rental section 122 reduces a motor vehicle of the corresponding present model which can be used, and instead, adds a reserved motor vehicles in the reservation condition table which is recorded in the reservation master 17. Simultaneously, the rental section 122 adds a motor vehicle of the reserved model which can be used, and instead reduces a reserved motor vehicle in the reservation condition table which is recorded in the reservation master 17 (step S26).

In the step S26, after the number of the motor vehicles which can be used and the number of the reserved motor vehicles for both the present model and the reserved model are calculated respectively, it is determined whether or not the number of the motor vehicles of the present model which can be used is 0 (zero) (step S27). If the number of the motor vehicles of the present model which can be used is 0 (zero) (YES in the step S27), an instruction for displaying an indication of “Reserved” on an LED display sections 38 on all the selected model of motor vehicles which are parked in the departing port is issued (step S28).

Also, if the number of the motor vehicles of the present model which can be used is not 0 (zero) (NO in the step S27), no particular operation is performed but process goes to a next step S29.

Next, the rental section 122 determines whether or not what is displayed on the LED display section 38 on the motor vehicle of the reserved model is “Reserved” according to the record for the condition of the corresponding reserved type of the motor vehicle in the reservation condition table which is recorded in the reservation master 17 (step S29). If what is displayed on the LED display section 38 on the motor vehicle of the reserved model is “Reserved” (YES in the step S29), an instruction for displaying an indication of “Reserved” on an LED display sections 38 on all the reserved model of the motor vehicles which are parked in the departing port is issued (step S30).

Consequently, it is permitted that the user may enter the motor vehicle of the present model. The rental section 122 transmits the rental permission and the PIN to the shared motor vehicle 2 via the inputting-outputting section 18; thus, the motor vehicle rental determining process is completed (step S31).

Also, in the step S29, if what is displayed on the LED display section 38 on the motor vehicle of the reserved model is not “Reserved” (NO in the step S29), no particular operation is performed but the process goes to a next step S31. In the step S31, it is permitted that the user may enter the motor vehicle of the present model, and the rental section 122 transmits the rental permission and the PIN to the shared motor vehicle 2 via the inputting-outputting section 18; thus, the motor vehicle rental determining process is completed.

On the other hand, if the reservation information of the user is not recorded in the step S21 (NO in the step S21), the rental section 122 determines whether or not there is a motor vehicle of the present model which can be used with reference to the reservation condition table which is recorded in the reservation master 17 (step S32).

If there is no motor vehicle of the present model which can be used in the step S32 (NO in the step S32), the rental section 122 refuses to allow the user to enter the motor vehicle of the present model; thus, the motor vehicle rental determining operation is completed (step S33).

Also, if there is a motor vehicle of the present model which can be used in the step S32 (YES in the step S32), the rental section 122 reduces the motor vehicle of the corresponding present model which can be used, and instead, adds a reserved motor vehicle in the reservation condition table which is recorded in the reservation master 17 (step S34).

After the number of the motor vehicles of the present model which can be used and the number of the reserved motor vehicles of the present model are calculated in the step S34, it is determined whether or not the number of the motor vehicles of the present model which can be used is 0 (zero) (step S35). If the number of the motor vehicles of the present model which can be used is 0 (zero) (YES in the step S35), an instruction for displaying an indication of “Reserved” on an LED display sections 38 on all the motor vehicles of the present model which are parked in the departing port is issued (step S36).

Consequently, it is permitted that the user may enter in the motor vehicle. The rental section 122 transmits the rental permission and the PIN to the shared motor vehicle 2 via the inputting-outputting section 18; thus, the motor vehicle rental determining process is completed (step S37).

If the number of the motor vehicles of the present model which can be used is not 0 (zero) (NO in the step S35), no particular operation is performed but the process goes to the next step S37 in which it is permitted that the user may enter the motor vehicle of the present model. The rental section 122 transmits the rental permission and the PIN to the shared motor vehicle 2 via the inputting-outputting section 18; thus, the motor vehicle rental determining process is completed.

### Industrial Applicability

As explained above, the present invention relates to a motor vehicle sharing system in which, from Monday through Friday in which only a “non-reserved rental” in which the motor vehicle can be rented without a reservation for a short period of time easily is permitted because a short-time-usage is frequent such as shopping to a neighborhood, and, on Saturday, Sunday, and holidays in which a “reserved rental” can be possible compatibly the motor vehicle is often used according to a planned schedule such as a travel. By doing this, it is possible to reduce a non-operating time only for obtaining reserved motor vehicles so as to improve an operating ratio in contrast to a motor vehicle sharing system in which the “reserved rental” and the “non-reserved rental” are used all the time.

Also, an accommodation for the user can be improved because it is possible to use the “non-reserved rental” even from Monday through Friday in which a usage of the motor vehicle is often in a short period of time in contrast to a conventional case in which the motor vehicles are allocated for the “reserved rental” from Monday through Friday; thus, it is possible to increase the motor vehicles which can be used.

Furthermore, the user can use the motor vehicle based on the most preferred rental condition by a reasonable price because a price-system is set according to the motor vehicle rental forms.

Furthermore, in contrast to the conventional system, according to the present invention, a vacant lot in each port is controlled and the reservation for the motor vehicle is temporarily stopped when there is no vacant lot in a system in which the “reserved rental” and the “non-reserved rental” which is preferable for the user because of the accommodation are compatibly employed. Therefore, it is possible to organize a motor vehicle sharing system in which the motor vehicles does not exceed capacity in the port, and the rearrangement of the motor vehicles is not necessary by the staff member.

Also, if it is not possible to make a reservation, the user who desires standing by a reservation can make a reservation in a first-come-first-reserved order, and the user is notified immediately after the reservation can be made. Therefore, it is possible to organize a motor vehicle sharing system in which the accommodation for the user is not deteriorated, or the user complaints.

Furthermore, in the system of the present invention, the number of the motor vehicles which can be used and the number of the reserved motor vehicles are acknowledged per a model of the motor vehicle such that a particular motor vehicle is not allocated to a reservation by the user; thus, the motor vehicles are rented by controlling the number of the motor vehicles. Therefore, the user can choose and use a desirable motor vehicle freely such as a motor vehicle which is located the most closely to an entrance of the port, a cleanest motor vehicle, a motor vehicle having a preferred body color when the user actually goes to the port.

Also, it is possible to change the model of the motor vehicle just before the user uses the motor vehicle; thus, it is convenient for the user.

Therefore, it is possible to deal with a motor vehicle sharing system easily in which a common “reserved rental” and the “non-reserved rental” in which the motor vehicle parked in the port is used by the user who goes to the port directly without a reservation are compatibly employed; thus, it is very useful.

1. A motor vehicle sharing system comprising a control center which is provided with a controlling device for controlling a motor vehicle which is parked in a parking area for renting the motor vehicle to a user, wherein,
the controlling device comprises:
a data storing section which stores a plurality of combinations of a motor vehicle rental form which is defined according to a time length of rental for a motor vehicle to a user and a period which is supposed to be applied for a rental data for renting the motor vehicle to the user;
a rental setting section switching the combinations of the motor vehicle rental forms periodically according to the applied period according to the rental data which is stored in the data storing section so as to rent the motor vehicle; and
a price controlling section which sets different prices according to the motor vehicle rental forms and charges a billing price to the user according to the user's usage condition of the motor vehicle.

2. A motor vehicle sharing system according to claim 1, wherein the rental data contains a first setting period in which only the motor vehicle rental form for renting the motor vehicle on an hourly basis is performed, and a second setting period in which either one of the motor vehicle rental form for renting the motor vehicle on a daily basis or the motor vehicle rental form for renting the motor vehicle on an hourly basis is selectively performed.

3. A motor vehicle sharing system according to claim 2, wherein, in the price controlling section, a usage price for the motor vehicle rental form for renting the motor vehicle on an hourly basis increases in proportion with time, and a usage price for the motor vehicle rental form for renting the motor vehicle on a daily basis is fixed for a day.

4. A motor vehicle sharing system comprising a control center which is provided with a controlling device for controlling a motor vehicle which is parked in a parking area which is called as a port for renting the motor vehicle to a user, wherein, the controlling device comprises:
a reservation registering section which performs a rental allocation of the motor vehicle according to a reservation information which contains a departing port and an arriving port which are from the user and calculates a planned number of motor vehicle to be parked for each port; and
a reservation determining section which stops the rental and the reservation of the motor vehicle which is supposed to arrive at a port when the planned number of motor vehicle to be parked in the port calculated by the reservation registering section reaches a parking capacity of the port.

5. A motor vehicle sharing system according to claim 4 which is provided with a stand-by reservation setting section which lets the user select whether or not standing by a reservation via a user's terminal when a reservation for using a motor vehicle is stopped by the reservation determining section and records a stand-by reservation data of the user when the user desires standing by the reservation.

6. A motor vehicle sharing system according to claim 5 which is provided with a stand-by reservation allocating section which uses the motor vehicle of which usage is stopped by the reservation determining section, cancels the reservation of the usage of the motor vehicle, and allocates the motor vehicle for the user whose stand-by reservation data is recorded in the stand-by reservation setting section preferentially wherein the planned number of motor vehicle to be parked is equal to the parking capacity in the arriving port.

7. A motor vehicle sharing system according to claim 6 wherein the stand-by reservation allocating section is provided with a notifying section which notifies the user who desires standing by the reservation that the motor vehicle is allocated when the motor vehicle is allocated successfully.

8. A motor vehicle sharing system comprising a control center which is provided with a controlling device for controlling a motor vehicle which is parked in a parking area which is called as a port for renting the motor vehicle to a user, wherein, the controlling device comprises:
an data storing section which stores the number of motor vehicle available to be used with reference to a motor vehicle type information;
a reservation registering section which performs a reservation registration of the motor vehicle according to an information of the departing port and a reservation information which includes a preferred motor vehicle type information which are received from the user's terminal and updates the number of motor vehicle available to be used; and
a renting section which permits the usage of the motor vehicle in the departing port according to the information of the user which is inputted by the user and the motor vehicle type information, and
the renting section rents the motor vehicle of which type is inputted by the user as long as the motor vehicle is rentable when the motor vehicle type information which is included in the reservation information is different from the motor vehicle type information which is inputted by the user at the departing port, and the number of motor vehicle available to be used which is stored in the data storing section is greater than zero, and updates a content in the number of motor vehicle available to be used which is stored in the data storing section.

9. A motor vehicle sharing system according to claim 8 wherein the renting section rents the motor vehicle of which type is inputted by the user as long as the motor vehicle is rentable when the information of the user which is inputted at the departing port is not registered in the reservation registration which is registered by the reservation registering section when the number of motor vehicle available to be used which is stored in the data storing section is greater than zero, and updates a content in the number of motor vehicle available to be used which is stored in the data storing section.

10. A motor vehicle sharing system according to any one of claims 8 and 9 wherein the motor vehicle type information contains information which indicates at least any one of a type of a motor vehicle, a type of a driving force transmitting function, equipments, and a color of a body of the motor vehicle.
